(19) United States
(12) Patent Application Publication
(10) Pub. No.: US 2021/0148567 A1
(43) Pub. Date: May 20, 2021

(54) Organic Colorant Complexes from Reactive Dyes and Articles Containing the Same

(71) Applicant: Milliken & Company, Spartanburg, SC (US)

(72) Inventors: Xiaoyong Michael Hong, Greer, SC (US); Chunping Xie, Shanghai (CN); Brian Sun, Shanghai (CN); Mary E. Mason, Moore, SC (US)

(73) Assignee: Milliken & Company, Spartanburg, SC (US)

(21) Appl. No.: 17/153,941

(22) Filed: Jan. 21, 2021

Related U.S. Application Data
(62) Division of application No. 16/244,879, filed on Jan. 10, 2019.
Application No. 16/244,879 is a continuation of application No. 14/683,163, filed on Apr. 10, 2015.
(60) Provisional application No. 61/982,368, filed on Apr. 22, 2014.

(51) Int. Cl. F23D 14/82; F23D 14/42; F23D 14/54; F23D 14/48; F23D 14/38

(52) U.S. Cl. CPC F23D 14/82; F23D 14/42; F23D 14/60; F23D 14/48; F23D 14/38; F23D 14/54

(57) ABSTRACT

An organic colorant complex with the following general structure:

ABₙ(DE)ₘTₓQ_{y}

wherein A is an organic chromophore; B is an electrophilic reactive group covalently bonded to A directly or through a linking group; D is a nucleophilic linking group covalently bonding B and E, selected from the group consisting of NR, O, S, and 4-oxyanilino (—HN-Ph-O—); wherein R is selected from the group consisting of H, alkyl, aryl, and E; E is an organic alkyl and aryl group or an end group; T is an ionic group covalently linked to A; Q is an organic cation, bonded to the organic chromophore A through ionic interaction with T; n, m, x, and y are independent integers from 1 to 10.

### CROSS REFERENCE TO RELATED APPLICATIONS

This application is a divisional of and claims priority to U.S. patent application Ser. No. 16/224,879, entitled “Organic Colorant Complexes from Reactive Dyes and Articles Containing the Same,” which was filed on Dec. 19, 2018, which is a continuation of and claims priority to U.S. patent application Ser. No. 14/683,163, entitled “Organic Colorant Complexes from Reactive Dyes and Articles Containing the Same,” which was filed on Apr. 10, 2015, which claims priority to and is a non-provisional of U.S. Patent Application Ser. No. 61/982,368, entitled “Organic Colorant Complexes from Reactive Dyes and Articles Containing the Same,” which was filed on Apr. 22, 2014, all of which are entirely incorporated by reference herein.

### FIELD OF THE INVENTION

The present invention relates to organic colorant complexes and methods for making the same, formulations containing such colorant complexes, and articles made from such formulations.

### BACKGROUND OF THE INVENTION

Colorants in general are classified as either pigments or dyes. Pigments are practically insoluble in the medium in which they are incorporated. Dyes dissolve during application, losing their crystal or particulate structure in the process. Pigments are classified as either organic or inorganic. Organic pigments are based on carbon chains and carbon rings. However, they can also contain metallic (inorganic) elements that help stabilize the properties of the organic component. Inorganic pigments are usually metallic salts precipitated from solutions. The dried, precipitated pigment might be in a form that can be used immediately, but often these raw materials require further mechanical processing, heating or chemical treatment to render them more useful as pigments. Inorganic pigments have a much larger average particle size than organic pigments. The optimum particle size needed to achieve maximum light scattering—resulting in opacity—is between 400 and 800 nm (wavelength). The particles sizes of inorganic pigments are much closer to this optimum than those of organic pigments, which tend to be much lower. This is the main reason why most organic pigments are considered transparent and most inorganic pigments opaque. With their larger surface area, organic pigments give much higher color strength. However, for similar reasons, their dispersability is usually poorer. As a result of their chemical composition, inorganic pigments are stable in the presence of organic solvents—unlike many of the simpler organic pigments, which can dissolve—and have high resistance to pigment bleeding and migration. With a few exceptions, inorganic pigments have higher heat stability than organic pigments. However, light fastness and weatherability vary more widely. Pigments usually have low tinting strength and a dull shade, which can limit the aesthetic qualities of articles which are produced using them. Pigments typically lack solubilizing groups, which frequently allows the pigment particles to aggregate and form larger secondary and tertiary aggregate particles during production processes. Owing to these difficulties, coatings colored with conventional pigments often exhibit poor color retention, have a dark or dull shade, or contain unsuitable variations in color depth. While these problems can be partially addressed through the addition of dispersing agents or by utilizing pigment dispersions, these measures often result in increased production costs and still require great care to minimize color variations produced by settling of the pigment(s) and/or incompatibility of these components with the resin. Dyes, on the other hand, typically contain solubilizing groups that can facilitate dispersion of the dye in a suitable medium. Dyes also typically exhibit relatively high tinting strength, good transparency, good thermal stability, and acceptable resin compatibility. Nevertheless, dyes typically exhibit poor weather durability, poor water resistance, poor oil resistance, and often migrate or bleed through to the transfer substrates of the coatings.

There are wide applications for pigments and dyes. Dyes give high transparency and bright shade. They are used in dyeing fabrics, coatings, paints, printing inks, inkjet inks, wood finishing & staining, paper and pulp, plastics, foams, leathers, all kinds of fluids, adhesives, foods and cosmetic, drugs, medicine, antifreeze, coolants, fuel, waxes, candles, detergents, soap, cleaners, fabric softeners, de-icing formulations, agriculture products and fertilizers, art supplies, beverages, ceramics, glass, construction materials. Pigments are less transparent than dyes. The major applications include coatings, printing inks, leather and textile finishing, plastics, cements, glass, cosmetics, paints.

Reactive dyes have good fastness properties owing to the covalent bonding that occurs during dyeing. Reactive dyes are most commonly used in dyeing of cellulose (cotton, flax), wool and nylon. Reactive dyeing is now the most important method for the coloration of cellulosic fibers. Reactive dyes come with monofunctional, or bifunctional and multifunctional reactive sites. With more reactive groups, the dye has better fixation while the cost is higher. There are methods to further modify the reactive dyes to make useful colorants. U.S. Pat. No. 5,151,106 teaches a method to covalently bind reactive dyes on to a hydrophilic polymer, which is a contact lens made from free radically polymerization of mixture of monomers. US 20120225803 discloses a laundry detergent containing polymeric shading dyes made from reactive dyes and polyethylene imines. WO 2012130492 discloses a laundry treatment composition containing dye polymers where polyvinyl alcohol polymers tethered to reactive dyes. WO 2012098046 discloses a polymeric shading dye made from a hydroxyalkyl cellulose and reactive dyes. U.S. Pat. No. 4,070,296 discloses toner particles made from an aminolyzed polymer covalently bonded with a reactive dye. WO2012126987 discloses dye composition comprising a peptide dye, said peptide dye comprising a peptide covalently bound to a negatively charged reactive dye; in which the peptide dye is obtainable by reacting a peptide containing a primary amine, secondary amine, OH, SH group or mixtures with a negatively charged reactive dye. U.S. Pat. No. 5,766,268 discloses a colorant made from a reactive dye having an electrophilic reactive group reacted with a poly(oxyalkylene) moiety having a nucleophilic reactive group. U.S. Pat. No. 6,287,348 discloses colorants comprising organic chromophores, in particular reactive dyes, which comprise electrophilic reactive groups, and which are also covalently bonded to fatty amine moieties through amino linking groups. U.S. Pat. No. 5,789,515 discloses a colorant composition prepared from a reactive dye AB which is reacted with XYZ, a poly(oxyalkylene)-polysiloxane copolymer. U.S. Pat. No. 5,773,405 discloses a cleaner composition comprising a colorant made from a reactive dye having an electrophilic reactive group reacted with a poly(oxyalkylene)-containing moiety having a nucleophilic reactive group. WO2009030344 discloses colorants prepared from reactive dyes and polyether polyol. U.S. Pat. No. 5,770,557 discloses a liquid fabric softener composition comprising a colorant made from a reactive dye having an electrophilic reactive group reacted with a poly(oxyallylene)-containing moiety having a nucleophilic reactive group. U.S. Pat. No. 5,725,794 discloses an antifreeze composition containing a poly(oxyalkylene)-substituted colorant made from reactive dyes.

U.S. Pat. No. 5,948,152 discloses liquid complexes of anionic organic dyes with quaternary ammonium compounds which are homogeneous and thus substantially free of unwanted inorganic salts.

U.S. Pat. No. 5,938,828 discloses solid complexes of anionic organic dyes with quaternary ammonium compounds which have average molecular weights of below about 900 which are substantially free from unwanted salts.

U.S. Pat. No. 5,948,153 discloses water-soluble complexes of optical brighteners with quaternary ammonium compounds which are substantially free from unwanted salts.

U.S. Pat. No. 6,046,330 discloses complexes of ultraviolet absorbers with quaternary ammonium compounds which are substantially free from unwanted salts.

U.S. Pat. No. 8,273,166 discloses a phase change ink composition containing colorants made from anionic dyes and N-alkyl or N-aryl quaternary ammonium cations.

U.S. Pat. No. 6,248,161 discloses a water-fast, dye-based, aqueous ink-jet ink which contains anionic dye and at least one water-fast phosphonium salt.

Neither colorants prepared from reactive dyes with nucleophile nor colorants from anionic dyes with quaternary ammonium compounds can be tailored to have all the desired properties. There is need for a colorant, which can be tuned in many ways to possess different properties, which has the bright shade and high transparency of dyes and non-migration and good light fastness of pigments. The present invention provides such colorants, methods for producing the same and articles containing such colorants.

### BRIEF SUMMARY OF THE INVENTION

The present invention relates to an organic colorant complex with the following general structure:

ABₙ(DE)ₘTₓQ_{y}
wherein A is an organic chromophore; B is an electrophilic reactive group covalently bonded to A directly or through a linking group; D is a nucleophilic linking group covalently bonding B and E, selected from the group consisting of NR, O, S, and 4-oxyanilino (—HN-Ph-O—); wherein R is selected from the group consisting of H, alkyl, aryl; E is an organic end group; T is an ionic group covalently linked to A, either anionic or cationic, preferably anionic group; Q is a counterion, bonded to the organic chromophore through ionic interaction with T; n, m, x, and y are independent integers from 1 to 10.

The inventive organic colorant complex can be prepared by the following general methods: (a) A reactive dye with structure of ABₙTₓMₓ, (where A, B and T as defined above; M is a metal counter cation) reacts with a nucleophile organic compound, DE, as defined above, under base condition. (b) The anionic dye from step (a), ABₙ(DE)ₘTₓMₓ, reacts with an organic cationic compound, Q⁺Z⁻ (where Q is cation and Z is the anion) to form the inventive organic colorant complex, ABₙ(DE)ₘTₓQ_{y}. (c) The colorant complex is purified to remove inorganic salts. The resulting colorant complexes can be liquid, paste or solid at ambient condition. They can be highly water soluble or totally water insoluble depending on the nucleophile and cationic compound used to make such complex. They can be polymers or non-polymers. They can hydrophobic or hydrophilic or somewhere between.

The present invention colorant complexes are useful for applications where high color concentrations without formation of undesired precipitates is required. The colorants can have a low staining factor and thereby reduce or eliminate staining on most hard surfaces, skin, fabrics, and equipment. Such colorants can often be cleaned up with cold water. The colorants of the present invention are especially suited for non-ink applications requiring a lower stain factor. For example, such applications include dyes for cleaning agents where it is desired that the dye not tint the items cleaned. The colorants of the present invention can be used over a wide pH range and are compatible with fragrances and preservatives, without complexing or destabilizing the resulting mixture. They are also compatible with most cationic, anionic, non-ionic and quaternary systems. Because these colorants make true solutions, not emulsions or dispersions, the resulting formulations are clear and brilliant in appearance. The colorants can be incorporated into a coating formulation for their good compatibility, bright color shade, and good non-migration property. The colorants can be used for dyeing hydrocarbons, thermoplastics, thermosets, and waxes, as well as within ink-jet and printing ink formulations, dyeing aqueous compositions, organic formulations.

### DETAILED DESCRIPTION OF THE INVENTION

The term “polymeric colorant” as used herein refers to that there are at least two repeat units in the molecule structure and the molecular weight of the molecule is at least 300.

The present invention relates to an organic colorant complex with the following general structure (1):

ABₙ(DE)ₘTₓQ_{y} (I)
wherein A is an organic chromophore; B is an electrophilic reactive group covalently bonded to A directly or through a linking group; D is a nucleophilic linking group covalently bonding B and E, selected from the group consisting of NR, O, S, and 4-oxyanilino (—HN-Ph-O—); wherein R is selected from the group consisting of H, alkyl and aryl; E is an organic moiety or end group; T is an ionic group covalently linked to A, either anionic or cationic, preferably anionic group; Q is a counterion, bonded to the organic chromophore through ionic interaction with T; n, m, x, and y are independent integers from 1 to 10, they can be the same or different.

This invention includes a colorant compound made from a reactive dye as defined by the formula (II):

ABₙTₓMₓ (II)
wherein A is an organic chromophore, B is an electrophilic reactive group covalently bonded to A directly or through a linking group, T is an anionic group covalently linked to A, M is a cationic metal ion, n and x are integer of 1 to 10.

The group A is a chromophore, including azo such as monoazo, bisazo and polyazo including their complexes with Cr, Fe, Co, and Cu, phthalocyanine, anthraquinone, aza[18]annulene, formazan copper complex, triphenodioxazine, nitroso, nitro, diarylmethane, triarylmethane, xanthene, acridene, methine, thiazole, indamine, azine, oxazine, thiazine, quinoline, indigoid, indophenol, lactone, aminoketone, hydroxyketone, and stilbene chromophores. Preferably, the reactive dye incorporates an azo, phthalocyanine or anthraquinone chromophore group. The reactive dye moieties AB contain organic chromophore A and at least one electrophilic functional group B. When multiple functional groups are provided, it is often desirable that the groups vary in reactivity, to maximize conversion. Examples of electrophilic functional groups, BL, which may be incorporated into the reactive dye include: monohalotriazine; dihalotriazine; monohalopyrimidine; dihalopyrimidine; trihalopyrimidine; dihaloquinoxaline; dihalopyridazone; dihalophthalazine; halobenzothiazole; mono-(m-carboxypyridinium)-triazine; amino epoxide; methylamino; sulfatoethyl sulfone; sulfatoethyl sulfonamide; chloroethyl sulfone; vinyl sulfone; phenylamino sulfone; acrylamide; alpha-haloacryloylamide; alpha, beta-dihalopropionyl amide; halosulfonyl pyrimidine; sulfatoethylamino sulfone; sulfatopropionamide; halosulfothiazinylamide and haloacetylamide. The halo component may be selected from fluorine, chlorine and bromine. Preferably, the reactive dye incorporates an electrophilic functional group selected from monochlorotriazine, monofluorotriazine, dichlorotriazine, sulfatoethyl sulfone, vinyl sulfone, 2,3-dichloroquinoxaline, and 2,4-difluor-5-chloropyrimidine groups. When there is more than one electrophilic reactive group present in a reactive dye, it is possible the two or more reactive groups are different to each other.

Reactive dyes meeting the above description are commercially available, described in the Colour Index, 3rd Edition, the Society of Dyers and Colourists (1971) and in the available published literature. By way of example and not limitation, the following reactive dyes may be employed: C.I. Reactive Black 5, C.I. Reactive Blue 2, C.I. Reactive Blue 4, C.I. Reactive Blue 5, C.I. Reactive Blue 7, C.I. Reactive Blue 15, C.I. Reactive Blue 19, C.I. Reactive Blue 27, C.I. Reactive Violet 3, C.I. Reactive Violet 5, C.I. Reactive Red 2, C.I. Reactive Red 24, C.I. Reactive Orange 4, C.I. Reactive Orange 13, C.I. Reactive Orange 16, C.I. Reactive Orange 78, C.I. Reactive Yellow 3, C.I. Reactive Yellow 13, C.I. Reactive Yellow 14, C.I. Reactive Yellow 17, and C.I. Reactive Yellow 95.

Reactive dyes are also described in Industrial Dyes (K. Hunger ed. Wiley VCH 2003). Many reactive dyes are listed in the color index (Society of Dyers and Colourists and American Association of Textile Chemists and Colorists). Reactive groups are preferably selected from heterocyclic reactive groups and/or a sulfooxyethylsulfonyl reactive group (—SO₂CH₂CH₂OSO₃Na).

The sulfooxyethylsulfonyl reactive group converts to a vinyl sulfone in alkali. The heterocyclic reactive groups are preferably nitrogen contains aromatic rings bound to a halogen or an ammonium group or a quaternary ammonium group, which react with NH₂ or NH groups of the peptides to form covalent bonds. The halogen is preferred, most preferably Cl or F. Preferably the reactive dye contains more than one reactive group, preferably two or three.

Preferably, the reactive dye comprises a reactive group selected from dichlorotriazinyl, difluorochloropynmidine, monofluorotrazinyl, dichloroquinoxaline, vinylsulfone, difluorotriazine, monochlorotriazinyl, bromoacrlyamide and trichloropyrimidine. With the exception of copper phthalocyanine based dyes the dye does not comprise a metal complex dyes, preferably the dye does not comprise a based azo metal complex dye. The reactive group may be linked to the dye chromophore via an alkyl spacer for example: dye-NH—CH₂CH₂-reactive group. Especially preferred heterocyclic reactive groups are

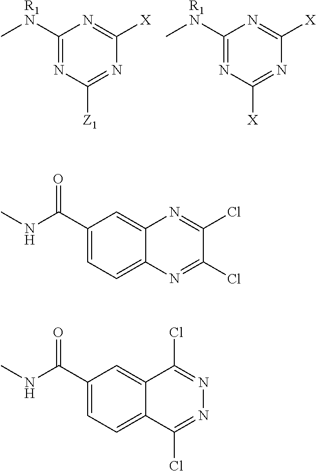

Wherein R₁ is selected from H or alkyl, preferably H;
X is selected from F or Cl;
When X═Cl, Z₁ is selected from —Cl, —NR₂R₃, —OR₂, —S0₃Na;
When X═F, Z is selected from —NR₂R₃;
R₂ and R₃ are independently selected from H, alkyl and aryl groups. Aryl groups are preferably phenyl and are preferably substituted by —S0₃Na or —S0₂CH₂CH₂OS0₃Na. Alkyl groups are preferably methyl or ethyl.

The phenyl groups may be further substituted with suitable uncharged organic groups, preferably with a molecular weight lower than 200. Preferred groups include —CH₃, —C₂H₅, and —OCH₃. The alkyl groups may be further substituted with suitable uncharged organic groups, preferably with a molecular weight lower than 200. Preferred groups include —CH₃, —C₂H₅, —OH, —OCH₃, —OC₂H₄OH. Most preferred heterocyclic reactive groups are selected from

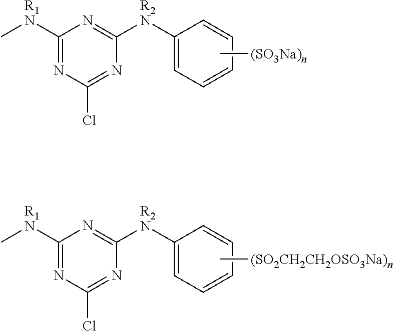

wherein R₁ and R₂ are selected from H or alkyl, preferably H;
wherein n=1 or 2, preferably 1.

Preferably the reactive dye contains more than one reactive group, preferably two, three or four. Preferably, the reactive dye comprises a chromophore selected from azo, anthraquinone, phthalocyanine, formazan and triphendioaxazine. Where the dye is an azo dye it is preferred that the azo dye is not an azo-metal complex dye.

Examples of reactive dyes include reactive black 5, reactive blue 19, reactive red 2, reactive blue 171, reactive blue 269, reactive blue 11, reactive yellow 17, reactive orange 4, reactive orange 16, reactive green 19, reactive brown 2, and reactive brown 50.

Reactive blue dyes are preferably selected from anthraquinone, mono azo, bis-azo, triphenodioxazine, and phthalocyanine, more preferably anthraquinone, bis-azo, and triphenodioxazine, most preferably bis-azo and triphenodioxazine.
A preferred blue bis-azo dye is of the form:

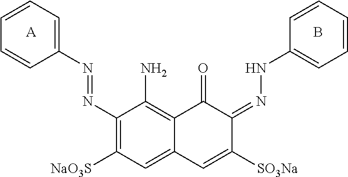

wherein one or both of the A and B rings are substituted by a reactive group. The A and B rings may be further substituted by sulphonate groups (SO₃Na). The A and B rings may be further substituted with suitable uncharged organic groups, preferably with a molecular weight lower than 200. Preferred uncharged organic groups are —CH₃, —C₂H₅, and —OCH₃.

A preferred blue anthraquinone dye is of the form:

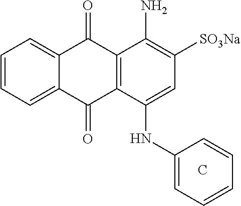

wherein the C ring is substituted by a reactive group. The dye may be further substituted with sulphonate groups (SO₃Na) and suitable uncharged organic groups, preferably with a molecular weight lower than 200. Preferred uncharged organic groups are —CH₃, —C₂H₅, and —OCH₃.

A preferred blue triphenodioxazine dye is of the form:

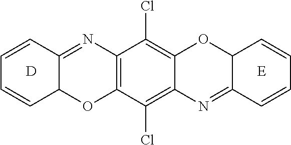

wherein the D and E rings are substituted by a reactive group. Preferably, the D and E rings are further substituted by sulphonate groups (SO₃Na).

Examples of reactive blue dyes are reactive blue 2, reactive blue 4, reactive blue 5, reactive blue 7, reactive blue 15, reactive blue 19, reactive blue 27, reactive blue 29, reactive blue 49, reactive blue 50, reactive blue 74, reactive blue 94, reactive blue 246, reactive blue 247, reactive blue 247, reactive blue 166, reactive blue 109, reactive blue 187, reactive blue 213, reactive blue 225, reactive blue 238, and reactive blue 256. Further structures are exemplified below:

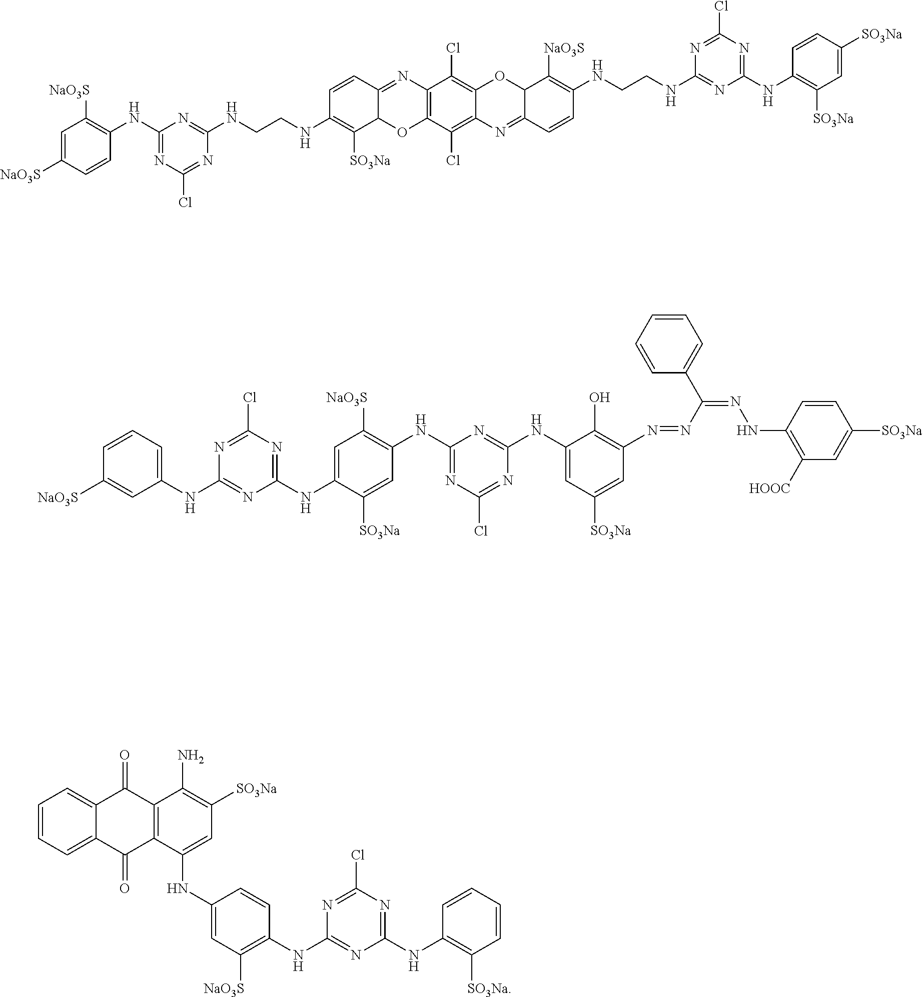

Reactive Red dyes are preferably selected from mono-azo and bis-azo dyes. A preferred reactive red azo dye is of the form:

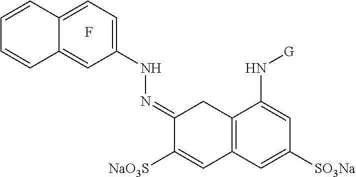

wherein the F ring is optionally extended to form a naphthyl group and is optionally substituted by groups selected from sulphonate groups (SO₃Na) and a reactive group. G is selected from a reactive group, H, or alky group. A reactive group must be present on the dye. Examples of reactive red dyes are reactive red 2, reactive red 3, reactive red 4, reactive red 8, reactive red 9, reactive red 12, reactive red 13, reactive red 17, reactive red 22 reactive red 24, reactive red 29, reactive red 33, reactive red 120, reactive red 139, reactive red 198 and reactive red 141. Further structures are exemplified below:

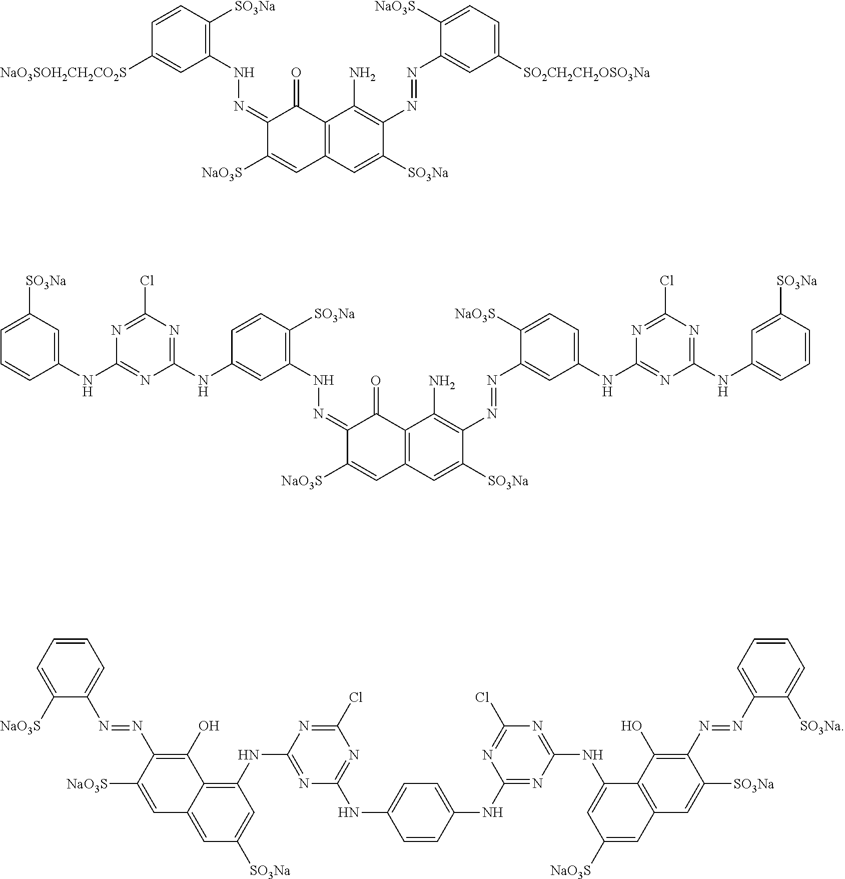

Reactive yellow and orange dyes are preferably selected from mono-azo dyes. Examples of reactive yellow and orange dyes are reactive yellow 1, reactive yellow 2, reactive yellow 3, reactive yellow 16, reactive yellow 17, reactive yellow 25, reactive yellow 39, reactive orange 107, reactive yellow 176 and reactive yellow 135. Further structures are exemplified below:

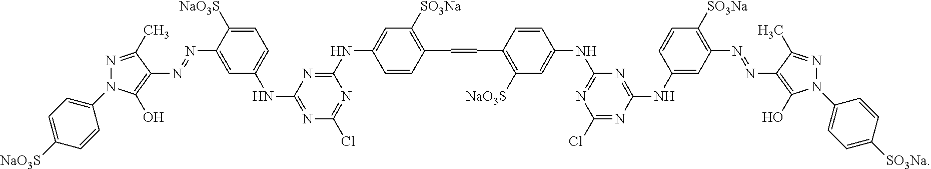

Combinations of reactive dyes may be used to obtain a wide color palette with use of a limited number of dyes. Preferably, a trichromate system consisting of a mixture of three reactive dyes may be used. Preferably, the trichromate system contains a combination of a reactive blue or a reactive black dye, a reactive red and a reactive yellow dye. For example, combinations may include reactive black 5, reactive yellow 176 and reactive red 239; or combinations may include reactive blue 176, reactive yellow 176 and reactive red 141.

A nucleophilic organic compound with a representative formula of DE, where D is an atom with lone electron pair for nucleophilic reaction, E is an organic moiety covalently linked to D, can react with a reactive dye as defined by formula (II) to form an anionic colorant with the general formula (III):

ABₙ(DE)ₘTₓMₓ (III)

A nucleophile is covalently linked to the electrophilic group B of a reactive dye AB through D, a nucleophilic linking group selected from the group consisting of NR, O, S, and 4-oxyanilino (—HN-Ph-O—); where R is selected from the group consisting of H, alkyl, and aryl; E is an organic moiety or end group of a nucleophile, which can be a polymer or oligomer. T is an anionic group covalently linked to A, M is a cationic metal ion; n, m and x are integer of 1 to 10.

A suitable nucleophile compound can be any primary or secondary amines, any alkyl or aromatic amines, substituted amines, monomeric or polymeric amines, amines with other compatible functional groups, amides, hydroxyl containing compounds, or sulfur compounds. Suitable examples nucleophilic reactants from which the present colorant compositions can be prepared include commercially available polyoxyalkyleneamines from the JEFFAMINE Huntsman Chemical product line and as described in Texaco Chemical Company, New Product Development brochures as the M, D, ED, DU, BuD, T, MNPA, and EDR series. These polyoxyalkylene amines contain primary amino groups attached to the terminus of a polyether backbone which can be based on either propylene oxide (PO), ethylene oxide (EO), or mixed EO/PO. The JEFFAMINE products consist of monoamines, diamines and triamines, which are available in a variety of molecular weights, ranging from 230 to 6000. JEFFAMINE compounds are designated by letter and number, the latter representing approximate molecular weight. JEFFAMINES (monoamines), D-Series (amine-terminated polypropylene glycols), ED-Series (polyether diamines based on a predominately polyethylene oxide backbone imparting water solubility), DU-Series (urea condensate of D-Series products to provide a diamine product of increased molecular weight which is amine terminated), BuD-Series (urea condensate of D-Series products to provide a urea terminated product), and T-Series (propylene oxide based triamines prepared by reacting PO with a triol initiator, followed by amination of the terminal hydroxyl groups). These amines are further described in U.S. Pat. No. 5,270,363 to Kluger et al., at columns 7 to 12.

The solubility of the colorant used in the present invention can vary by the relative hydrophilic/oleophilic character of the poly(oxyalkylene) substituent and the end group, as well as the presence or absence of ionic groups on the organic chromophore.

General Reaction Conditions for Preparation of Poly(oxyethylene)-Substituted Colorant:

In one aspect, one equivalent of reactive dyestuff is mixed with about 5-10% molar excess of nucleophilic polymer, one equivalent of sodium carbonate (or other suitable acid scavenger), and enough water to afford mixing. The reaction mixture is then heated to 80 degrees C., and the resultant solution is then phase separated. The concentrated polymeric colorant phase is then brought to a neutral pH and further diluted with water if desired.

Many polymeric amines or the mixtures of amines may be used to react with a reactive dye to form the polymeric colorant used to color various synthetic articles. It is desirable that the amines are primary amines. It is also desirable that the amines consist of polyalkylene oxide structure units. Preferably, the polyalkylene oxide is polyethylene oxide, which typically provides good water solubility and/or miscibility. There are many commercially available polymeric amines which can be used for this invention. For example, the polyoxyalkylene amines, such as Jeffamine® amines from Huntsman can be used, which include monoamines like M-600, M-100, M-2005 and M-2070; diamines like EDR-148, D-230, D-400, D-2000, XTJ-502, XTJ-511, and XTJ-512; triamines like T-403 and T-5000. Examples of amines having hydroxyl group include diethylene glycol amine, aminopropyl diethylene glycol (which is available from Dixie Chemical Company under the trade name DCA 163), and bis(hydroxyalkyl) diamines like APDEA and APDIPA from Tomah. Another series of glycol ether primary amines from Tomah include PA-EGM, PA-EGB, PA-EGH, PA-DEGM, PA-DEGB, PA-PGM, PA-PGB, PA-DPGM and PA-DPGB. Another series of di primary amines from Tomah include DPA-DEG, DPA-200E, DPA-400E, DPA-1000E, and NDPA-10.

Another example of a nucleophilic compound is a poly(oxyalkylene)-containing compound as DYZ, where D is the linking group, Y is a poly(oxyalkylene) chain, and Z is an organic end group. Two poly(oxyalkyene)-containing substituents may be bonded to reactive dye AB through a linking group comprising a trivalent atom, e.g., N. The number of poly(oxyalkylene) chains per chromophore may be from 1-6, preferably 1-4, most preferably 1, 2 or 3.

Poly(oxyalkylene)-Containing Substituent Y

Y can be a poly(oxyalkylene)-containing moiety comprising the formula (CₐH₂ₐO)ₘ (CbH_{2b}O)ₙ where a and b are different and from 1 to 8, preferably from 1 to 4, e.g., a is 2, b is 3, m is at least 3, preferably at least 11, e.g., where lower staining factor of the resulting colorant composition is desired; n is an integer from 0 to 15 inclusive, e.g., 0 or 1. The molecular weight of the Y moiety can be less than 4000 and can range from 130 to 4000, preferably from 480 to 4000. Typical of such Y substituents are poly(oxyalkylene) polymers and copolymers. In this regard, polyalkylene oxides and copolymers of same which may be employed to provide the colorant of the present invention are, without limitation, polyethylene oxides, polypropylene oxides, polybutylene oxides, copolymers of polyethylene oxides, polypropylene oxides and polybutylene oxides, and other copolymers including block copolymers, in which a majority of the polymeric substituent is polyethylene oxide, polypropylene oxide and/or polybutylene oxide. While such substituents generally have an average molecular weight in the range of from 130 to 4000, e.g., 130 to 1400, they should not be so limited.

In a particular embodiment of the present invention, Y can be described as a polysiloxane-poly(oxyalkylene) copolymer which incorporates:

(a) a polysiloxane segment characterized by a —Si(R¹)(R²)O— repeating group wherein R¹ and R² are each selected from the group consisting of alkyl, phenyl, vinyl, 3,3,3-trifluoropropyl, and hydrogen (preferably R¹ and R² are alkyl, with methyl especially preferred); and

(b) a polyether segment characterized by a poly(oxyalkylene) group which may be i) in the copolymer backbone or ii) pendent from a siloxane or silane repeating group.

Y copolymers having pendent poly(oxyalkylene) groups along a polysiloxane backbone may be synthesized by incorporating siloxane groups with reactive functionalities into the backbone of the polymer. The siloxane groups may be alkoxylated, esterified or otherwise provided with a poly(oxyalkylene) functionality. Copolymers having a polysiloxane backbone and pendent poly(oxyalkylene) groups are commercially available in the Masil Silicone Surfactants product line, available from PPG Industries, Inc., Gurnee, Ill., USA. Polysiloxane-polyether copolymers are disclosed in the following patents: Azechi et al. U.S. Pat. No. 5,271,868; Kasprzak et al. U.S. Pat. No. 5,300,667; and Fleuren et al. U.S. Pat. No. 5,376,301. Another method of synthesizing polysiloxane-polyether copolymers is disclosed by Jainlong Ni et al. “Synthesis of a Novel Polysiloxane-based Polymer Electrolyte and its Ionic Conductivity,” Polymers for Advanced Technologies Vol. 4, pp 80-84 (1993). Allyl polyethers are grafted onto polysiloxane to form the copolymer. Sela et al., “Newly Designed Polysiloxane-graft-poly(oxyethylene) Copolymeric Surfactants,” Colloid PolymSci 272:684-691 (1994) disclose comb grafted surfactants based on a poly(methylhydrogen siloxane)/poly(dimethylsiloxane) block copolymer backbone which is silated with a vinyl terminated poly(oxyethylene) group.

Alternatively, the polysiloxane-poly(oxyalkylene) copolymer is a block copolymer incorporating a poly(oxyalkylene) substituted silane, e.g., copolymer incorporating silane a group having the structure —Si(R³-poly(oxyalkylene)) (R⁴)—, wherein R³ is an alkylene group, preferably methylene or ethylene, and R⁴ is H, alkyl, or phenyl, preferably methyl. Such copolymers are commercially available, for example, as dimethylsiloxane-alkylene oxide copolymers available from Petrarch Systems, Silanes and Silicones Group, Bristol, Pa., USA.

Block copolymers having a poly(oxyalkylene) segment in the backbone may be synthesized by procedures well known in the art and are commercially available from Dow Corning, Midland, Mich., USA under the 5103 Fluid and Q2-5211 wetting agent product lines.

Y can also be described as a poly(oxyalkylene)-containing polysiloxane moiety selected from the group consisting of (OSi(R′)(R″))ᵢ O(SiR′R″O(CₐH₂ₐO)ₘ (C_{b} H_{2b} O)ₙ)ⱼ and (OSi(R′)(R″))ᵢ (R′″O(Cₐ H₂ₐ O)ₘ (C_{b}H_{2b}O)ₙ)ⱼ where R′ and R″ are each alkyl, preferably C₁ to C₄ alkyl, more preferably methyl, R′″ is alkylene, preferably C₁ to C₃ alkylene, more preferably ethylene, i and j are integers selected to provide a molecular weight for Y of 300 to 10000, preferably 450 to 5000, more preferably 800 to 1400, i is at least 3, j is at least 1, a and b are different and from 1 to 8, preferably from 1 to 4, more preferably from 2 to 3, m is at least 3, preferably 5 to 15, and n is from 0 to 15, preferably 0.

The poly(oxyalkylene)-containing substituent Y has a molecular weight which can range from 300 to 10000, preferably 450 to 5000, more preferably 800 to 1400.

Further description of the polysiloxane poly(oxyalkylene)copolymers useful in the present invention may be found in the Encyclopedia of Polymer Science and Engineering, John Wiley & Sons, Vol. 15, page 234-244 (1989) and the references cited therein.

End Group Z

The end group Z of poly(oxyalkylene)-containing substituent Y can be any suitable terminal group, e.g., one selected from the group consisting of hydroxyl, alkyl, e.g., C₁ to C₄ alkyl, amino, amido, alkyl ester, e.g., acetyl, phenyl ester, alkyl ether, alkyl acetal, and BA where Y has a nucleophilic end group (such as where the polysiloxane-poly(oxyalkylene) copolymer is a diamine). The end group can itself contribute to solubility characteristics of the colorant product. Examples of other suitable terminal groups are those disclosed in U.S. Pat. No. 5,270,363 to Kluger et al., for poly(oxyalkylene) polymers. When Z is XBA, the resulting colorant has the structure ABXYXBA wherein X, B and A are as described above.

A cationic group may comprise an amino, ammonium, imino, sulfonium, or phosphonium group.

A wide range of quaternary ammonium compounds, including quaternary ammonium salts, pyridium salts, piperidinium salts, and the like, have been shown to be useful for practicing the invention. A broad list of potentially useful quats within this invention includes trialkyl, dialkyl, dialkoxy alkyl, monoalkoxy, benzyl, and imidazolinium quaternary ammonium compounds. Various types of quaternary ammonium compounds can be adapted to the invention herein with success. The quaternary ammonium compounds are analogs of ammonium salts in which organic radicals have been substituted for all four hydrogens of the original ammonium cation. Substituents maybe alkyl, aryl, aralkyl, or alkoxylates, or the nitrogen may be part of a ring system. By ways of example, and not limitation, a list of preferred classes and examples of quaternary ammonium compounds is set forth in TABLE 1 below:

TABLE 1

| Class | Example |
|---|---|
| Trialkyl quats | Methyl tri(hydrogenated tallow) ammonium chloride |
| Dialkyl quats | Dicoco dimethyl ammonium chloride |
| Dialkoxy alkyl | Methyl bis(polyethoxyethanol) coco ammonium chloride |
| quats | |
| Monoalkoxy | Methyl (polypropylene glycol) diethyl ammonium |
| quats | chloride |
| Benzyl quats | Dimethyl tallow benzyl ammonium chloride |
| imidazolinium | Methyl tallow amido-2-tallow imidazolinium |
| quats | methylsulfate |

Other nitrogen based cationic compounds include 4-(dimethylamino)pyridinium tribromide, dodecylethyldimethylammonium bromide, 1-dodecylpyridinium chloride hydrate, dodecyltrimethylammonium bromide, 1-ethyl-3-methyl-1H-imidazolium chloride, 1-ethyl-4-(methoxycarbonyl)pyridinium iodide, 6-hydroxy-2,4,5-triaminopyrimidine sulfate, 2-hydroxy-4-methylpyrimidine hydrochloride, stearyl trimethylammonium chloride, p-xylylene-bis(tetrahydrothiophenium chloride), trimethyl sulfonium iodide, diphenyl iodonium chloride, ferrocenium hexafluorophosphate, dodecyldimethyl(3-sulfopropyl)ammonium hydroxide, 1-(N,N-dimethylcarbamoyl)-4(2-sulfo-ethyl)pyridinium hydroxide, and 2-ethyl-5-phenylisoxazolium-3′-sulfonate, cationic quaternary ammonium fluoroalkyl surfactant, such as FLUORAD FC-135 surfactant (manufactured by 3M Co. of St. Paul, Minn.), SURFLON S-121 surfactant (manufactured by Seimi Chemical Co., Japan), or Neos FTERGENT 300 surfactant (manufactured by Neos, Japan).

Other conventional cationic species including carbonium salts, iodonium salts, sulfonium salts, pyrrilium salts, phosphonium salts, etc. can also be used for this invention. Some of these cationic compounds can increase the water resistance of the colorant complexes. Phosphonium salts are selected from the group consisting of allyl triphenyl phosphonium bromide, allyl triphenyl phosphonium chloride, vinyl triphenyl phosphonium bromide, (3-bromobutyl)triphenyl phosphonium bromide, (4-bromobutyl)triphenyl phosphonium bromide, (bromodifluoromethyl)triphenylphosphonium bromide, chloroethylene triphenylphosphonium bromide, 1,1,1-trifluoroacetonyl triphenyl phosphonium bromide, methyl triphenyl phosphonium bromide, ethyl triphenyl phosphonium bromide, propyl triphenyl phosphonium bromide, n-butyl triphenyl phosphonium bromide, isopropyl triphenyl phosphonium bromide, n-pentyl triphenyl phosphonium bromide, acetonyl triphenyl phosphonium bromide, 4-carboxybutyl triphenyl phosphonium bromide, (ethoxycarbonylmethyl)triphenyl phosphonium bromide, (methoxymethyl)triphenyl phosphonium bromide, triphenyl phosphonium hydrobromide, (2-hydroxyethyl)triphenyl phosphonium chloride, (2-hydroxyethyl) triphenyl phosphonium bromide, [3-hydroxy-2-methylpropyl]triphenyl phosphonium bromide, [2-(trimethylsilyl)ethoxymethyl]triphenyl phosphonium chloride, methyltriphenoxy phosphonium iodide, [3-(dimethylamino)propyl]triphenyl phosphonium bromide, and dimethylaminoethyl triphenyl phosphonium bromide. Other phosphonium: a phosphonium salt selected from the group consisting of (ethoxycarbonylmethyl)triphenyl phosphonium bromide, (ethoxycarbonylmethyl)triphenyl phosphonium chloride, (methoxymethyl)triphenyl phosphonium bromide, triphenyl phosphonium hydrobromide, (2-hydroxyethyl)triphenyl phosphonium chloride, (2-hydroxyethyl)triphenyl phosphonium bromide, [3-hydroxy-2-methylpropyl]triphenyl phosphonium bromide, [2-(trimethylsilyl)ethoxymethyl]triphenyl phosphonium chloride, methyltriphenoxy phosphonium iodide, [3-(dimethylamino)propyl]triphenyl phosphonium bromide, acetonyl triphenyl phosphonium bromide, tetrakis(hydroxymethyl)phosphonium chloride, 2-acetonapthonyl triphenyl phosphonium bromide, 2′,5′-dimethoxyphenacyltriphenyl phosphonium bromide, 1-hydroxydodecyl triphenyl phosphonium bromide, 2-ethylindolinyl triphenyl phosphonium bromide, 3′-methoxyphenacyl triphenyl phosphonium bromide, 3-methylpyrridinyl triphenyl phosphonium bromide, phenacyl dimethylaminophenyl diphenyl phosphonium chloride, methyl(dimethylaminophenyl diphenyl)phosphonium bromide, [3-(ethoxycarbonyl)-2-oxypropyl]triphenyl phosphonium chloride, (2-hydroxybenzyl)triphenyl phosphonium bromide, benzotriazol-1-yloxytripyrrolidino-phosphonium hexafluorophosphate, triphenyl(2-pyridylmethyl) phosphonium chloride hydrochloride, (4-ethoxybenzyl)triphenyl phosphonium bromide, (3-benzyloxypropyl)triphenyl phosphonium bromide, phenacyl triphenyl phosphonium chloride, benzotriazol-1-yloxytris(dimethylamino)phosphonium hexafluorophosphate, and 2-acetonapthonyl triphenyl phosphonium bromide.

A cationic compound can be selected from suitable ionic liquid, comprising an organic cation and an inorganic or organic anion. Examples are N-ethyl-N′-methylimidazolium (EMIM), N-methylimidazolium (MEHIM), N-butyl-N′-methylimidazolium (BMIM), N-ethyl-N′-ethylimidazolium (EEIM), N-n-propyl-N′—N-propylimidazolium (PPIM), and other Basionics™ ionic liquid products from BASF.

Cationic polymers are selected from the group consisting of poly(vinylbenzyl trimethylammonium chloride), poly(4-vinylpyridine hydrochloride), polyethyleneimine 80% ethoxylated, polyaniline, and sulfonated poly(diallyldimethylammonium chloride).

Cationic polymers are suitable for the purposes of the present invention regardless of the number, type or concentration of the monomers used to make them. The cationic polymers can be in the form of a liquid or dried to a powder. Examples of such polymers are those marketed by Degussa under trade names Praestaret K-325 and Praestaret K-350 as well as Praestol E-125 and Praestor E-150.

The cationic polymers typically include cationic nitrogen-containing moieties such as quaternary ammonium or cationic amino moieties, or a mixture thereof. Any anionic counterions can be utilized for the cationic polymers so long as the water solubility criteria is met. Suitable counterions include halides (e.g., C, Br, I, or F, preferably Cl, Br, or I), sulfate, and methylsulfate. Others can also be used, as this list is not exclusive.

The cationic nitrogen-containing moiety will be present generally as a substituent, on a fraction of the total monomer units. Thus, the cationic polymer can comprise copolymers, terpolymers, etc. of quaternary ammonium or cationic amine-substituted monomer units and other non-cationic units referred to herein as spacer monomer units.

Suitable cationic polymers include, for example, copolymers of vinyl monomers having cationic amine or quaternary ammonium functionalities with water soluble spacer monomers such as acrylamide, methacrylamide, alkyl and dialkyl acrylamides, alkyl and dialkyl methacrylamides, alkyl acrylate, alkyl methacrylate, vinyl caprolactone, and vinyl pyrrolidone. The alkyl and dialkyl substituted monomers preferably have C₁-C₇ alkyl groups, more preferably C₁-C₃ alkyl groups. Other suitable spacer monomers include vinyl esters, vinyl alcohol (made by hydrolysis of polyvinyl acetate), maleic anhydride, propylene glycol, and ethylene glycol.

The cationic amines can be primary, secondary, or tertiary amines. In general, secondary and tertiary amines, especially tertiary amines, are preferred.

Amine-substituted vinyl monomers can be polymerized in the amine form, and then optionally can be converted to ammonium by a quaternization reaction. Amines can also be similarly quaternized subsequent to formation of the polymer. For example, tertiary amine functionalities can be quaternized by reaction with a salt of the formula R′X wherein R′ is a short chain alkyl, preferably a C₁-C₇ alkyl, more preferably a C₁-C₃ alkyl, and X is an anion which forms a water soluble salt with the quaternized ammonium.

Suitable cationic amino and quaternary ammonium monomers include, for example, vinyl compounds substituted with dialkylaminoalkyl acrylate, dialkylaminoalkyl methacrylate, monoalkylaminoalkyl acrylate, monoalkylaminoalkyl methacrylate, trialkyl methacryloxyalkyl ammonium salt, trialkyl acryloxyalkyl ammonium salt, diallyl quaternary ammonium salts, and vinyl quaternary ammonium monomers having cyclic cationic nitrogen-containing rings such as pyridinium, imidazolium, and quaternized pyrrolidone, e.g., alkyl vinyl imidazolium, alkyl vinyl pyridinium, alkyl vinyl pyrrolidone salts. The alkyl portions of these monomers are preferably lower alkyls such as the C₁-C₃ alkyls, more preferably C₁ and C₂ alkyls.

Suitable amine-substituted vinyl monomers for use herein include dialkylaminoalkyl acrylate, dialkylaminoalkyl methacrylate, dialkylaminoalkyl acrylamide, and dialkylaminoalkyl methacrylamide, wherein the alkyl groups are preferably C₁-C₇ hydrocarbyls, more preferably C₁-C₃, alkyls.

The cationic polymers hereof can comprise mixtures of monomer units derived from amine- and/or quaternary ammonium-substituted monomer and/or compatible spacer monomers.

Suitable cationic polymers include, for example: copolymers of 1-vinyl-2-pyrrolidone and 1-vinyl-3-methyl-imidazolium salt (e.g., chloride salt) (referred to in the industry by the Cosmetic, Toiletry, and Fragrance Association, “CTFA”, as Polyquaternium-16), such as those commercially available from BASF Wyandotte Corp. (Parsippany, N.J., USA) under the LUVIQUAT® tradename (e.g., LUVIQUAT FC 370®); copolymers of 1-vinyl-2-pyrrolidone and dimethylaminoethyl methacrylate (referred to in the industry by CTFA as Polyquaternium-11) such as those commercially available from Gaf Corporation (Wayne, N.J., USA) under the GAFQUAT tradename (e.g., GAFQUAT 755N®); cationic diallyl quaternary ammonium-containing polymers, including, for example, dimethyldiallylammonium chloride homopolymer and copolymers of acrylamide and dimethyldiallylammonium chloride, referred to in the industry (CTFA) as Polyquaternium 6 and Polyquaternium 7, respectively; and mineral acid salts of amino-alkyl esters of homo- and co-polymers of unsaturated carboxylic acids having from 3 to 5 carbon atoms, as described in U.S. Pat. No. 4,009,256.

Other cationic polymers that can be used include polysaccharide polymers, such as cationic cellulose derivatives and cationic starch derivatives. Cationic polysaccharide polymer materials suitable for use herein include those of the formula:

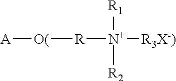

wherein:

P is an anhydroglucose residual group, such as a starch or cellulose anhydroglucose residual,

R is an alkylene oxyalkylene, polyoxyalkylene, or hydroxyalkylene group, or combination thereof,

R₁, R₂, and R₃ independently are alkyl, aryl, alkylaryl, arylalkyl, alkoxyalkyl, or alkoxyaryl groups, each group containing up to about 18 carbon atoms, and the total number of carbon atoms for each cationic moiety (i.e., the sum of carbon atoms in R¹, R² and R³) preferably being about 20 or less, and X is an anionic counterion.

Cationic cellulose is available from Amerchol Corp. (Edison, N.J., USA) in their Polymer JR® and LR® series of polymers, as salts of hydroxyethyl cellulose reacted with trimethyl ammonium substituted epoxide, referred to in the industry (CTFA) as Polyquaternium 10.

Another type of cationic cellulose includes the polymeric quaternary ammonium salts of hydroxyethyl cellulose reacted with lauryl dimethyl ammonium-substituted opoxide, referred to in the industry (CTFA) as Polyquaternium 24. These materials are available from Amerchol Corp. (Edison, N.J., USA) under the trade-name Polymer LM-200.

Other cationic polymers that can be used include cationic guar gum derivatives, such as guar hydroxypropyltrimonium chloride (commercially available from Celanese Corp. in their Jaguar® series). Other materials include quaternary nitrogen-containing cellulose ethers (e.g., as described in U.S. Pat. No. 3,962,418, incorporated by reference herein), and copolymers of etherified cellulose and starch (e.g., as described in U.S. Pat. No. 3,958,581).

Polyfunctional cationic salts may be useful herein and are selected from the group consisting of hexadimethrine bromide, p-xylylene-bis(tetrahydrothiophenium chloride), 1,1′-trimethylenebis[4-(hydroxyimino-methyl)pyridinium bromide], 1,1′-diheptyl-4,4′-bipyridinium dibromide, 1,1′-dioctadecyl-4,4′-bipyridinium diperchlorate, ethyl viologen dibromide, 1,1′-dioctadecyl-4,4′-bipyridinium bromide, and ferrocenium hexafluorophosphate.

The colorant complexes of the present invention can be readily prepared by the following methods:

Method 1: First, covalently bonding reactive dye AB to a nucleophile by heating an aqueous or organic composition of nucleophile and the dye to a temperature of at least 30° C. preferably at least 60° C. Generally, increasing the temperature will increase the rate of reaction. For example, at 85° C. the reaction is typically complete in two hours. The pH of the reaction composition is maintained to avoid protonating amine if present in the reaction mixture. A molar excess of the nucleophile is typically employed to insure complete conversion and to minimize the presence of unreacted and unsubstituted reactive dye, which can cause undesired properties. Acid scavenger such as sodium carbonate is preferably present in the reaction mixture, say, in about equivalent amounts. Second, the formed anionic colorant from step 1 is further reacted to a cationic compound to form the desired colorant complex. Third, the colorant complex is further purified to remove undesired inorganic salts by either extraction or washing, so the final product is essentially salt free.

Method 2: All starting raw materials, including reactive dye, nucleophile compound, cationic compound, and suitable solvents and bases are heated together in a reactor in one step until the desired colorant complex is formed and the reaction is completed. The crude product is further purified to remove undesired salts.

The basic way to practice the invention is first determine the desired reactive dye for its shade, lightfastness, thermal stability, and the like, for the subject substrate to be colored; second, select the appropriate nucleophile that can covalently attach to the reactive dye; third, react the two compounds together to form anionic colorant; fourth, select the appropriate cationic compound for the subject substrate based on the necessarily required physical properties such as migration, uniform dispersion, solubility, washfastness, and the like; fifth, react the anionic colorant from step 3 and cationic compounds together to form a colorant complex; and last, remove the unwanted salts formed from the reaction.

The inventive organic colorant complexes are useful for a wide variety of product applications. For example, colorants can be used in tinting of polymers, providing coloration to aqueous solution(s), and affording color to solid or semi-solid products such as detergents. Crayons, ink compositions, toilet bowl colorants, plastics, soaps, and many other products can be colored using the colorant complexes.

The inventive complexes can be used for coloring many different and diverse media, including thermoplastic composites, thermosets, and waxes, and can also be utilized within printing ink formulations, all as merely examples. The inventive complexes possess the advantageous properties of polymeric colorants such as high tint strength, desirable migratory properties, and minimal impact on the physical properties of plastics. Also, virtually all types and classes of chromophores can be adopted to practice this invention. Such chromophore molecules, however, preferably have at least one reactive site (such as vinyl sulfone) and one anionic functional group (such as a sulfonic or carboxylic acid functionality) in order to form the necessary complex with the cationic compound. The cationic ammonium group bonds with such acid (i.e., sulfonic and/or carboxylic) groups through ionic bonds. It is not fully understood how the interaction between the cationic moiety of the quaternary ammonium and the anionic moieties of the anionic dyes is accomplished; however, as discussed above, it is evident that the quaternary ammonium compound has a greater affinity for the anionic dye rather than for the anionic counter ion to which such quats are generally bonded. The same holds true for the anionic dye which has more of an affinity for the cationic quat rather than for the cationic counter ion. Upon complexation, then, the free counter ions of both components react together to form the aforementioned unwanted salts which require removal (at least to a substantial extent) from the resultant complex in order to provide the desired aforementioned beneficial properties. The permissible level of remaining salt, and thus the definition of substantially salt-free for this invention, within the inventive complex is, at most, about 5,000 ppm. In theory, it is impossible to remove all of the unwanted salt from such complexes; however, at such low, permissible, and attainable levels of salt content, the desired migration and colorant characteristics may be obtained.

Certainly, a level of no salt at all would be most preferred, although such a level is, as noted above, nearly impossible to achieve.

The term hydrocarbon is intended to encompass any organic composition comprised primarily of carbon and hydrogen in which reactive dyes are substantially insoluble. More specifically, hydrocarbon is intended to encompass fuels (such as kerosene), mineral spirits, oils, diluents, solvents, and any other such hydrogen and carbon-containing organic compositions in which unmodified reactive dyes are substantially insoluble. The term wax is intended to encompass any wax or wax-like substance in which unmodified reactive dyes are substantially insoluble. Waxes are generally defined as esters of high-molecular weight fatty acid with a high molecular weight alcohol or mixtures of any such esters. More specific types of such waxes include mineral waxes, such as paraffin, montan, ozokerite, microcrystalline, earth, and the like; animal waxes, such as beeswax, waspwax, Chinesewax (insectwax), and the like; vegetable waxes, such as camauba, sugarcane wax, candelilla, flax wax, and the like; and synthetic waxes, such as Fischer-Tropsch wax, polyethylene wax, and the like. Wax compositions can be molded into different articles such as candles and crayons (with the addition of sufficient amounts of suitable plasticizers, such as stearic acid), ear plugs, and the like. The colorants are generally added in proportions of from about 0.005 to about 15.0% by weight of the wax media, preferably from about 0.01 to about 10.0%, more preferably from about 0.05 to about 5.0%, and most preferably from about 0.1 to about 3.0%.

The following examples are given for illustration and should not be considered as limiting the scope of the invention.

### Examples: Synthesis of Colored Complexes from Reactive Dyes

### Example 1: Red Complex from Reactive Red 120, 3-(2-ethylhexyloxy)propylamine and Aliquat® 336

14.7 gram of Reactive Red 120 (50% dye content), 2.81 gram of 3-(2-ethylhexyloxy)-propyl amine, 0.84 gram of sodium bicarbonate and 30 mL of water were charged into a reactor equipped with agitator, temperature control and condenser. The mixture was heated to 80° C. for several hours until the starting material Reactive Red 120 was gone as monitored by TLC. Then 12.1 gram of Aliquat®336 was added slowly and stirred at 80° C. for one hour. The reaction mixture was cooled to room temperature and dark red solid was precipitated. The solid was filtered and washed with water to remove salts. 24.1 gram of red solid with color value of 12.8 was obtained.

### Example 2: Red Complex from Reactive Red 120, Jeffamine M-1000 and Aliquat®336

14.7 gram of Reactive Red 120 (50% dye content), 11 gram of Jeffamine M-1000, 0.84 gram of sodium bicarbonate and 50 mL of water were charged into a reactor equipped with agitator, temperature control and condenser. The mixture was heated to 80° C. for several hours until the starting material Reactive Red 120 was gone as monitored by TLC. Then 12.1 gram of Aliquat® 336 was added slowly and stirred at 80° C. for one hour. The reaction mixture was cooled to room temperature and 150 mL of chloroform was added. The chloroform layer was washed with water to remove salts. 20.6 gram of dark red paste with color value of 9.6 was obtained after removing chloroform.

### Example 3: Red Complex from Reactive Red 120, Polyglycol Amine H-163 and Ethoquad® C/25

14.7 gram of Reactive Red 120 (50% dye content), 2.0 gram of Polyglycol Amine H-163, 0.84 gram of sodium bicarbonate and 60 mL of water were charged into a reactor equipped with agitator, temperature control and condenser. The mixture was heated to 80° C. for several hours until the starting material Reactive Red 120 was gone as monitored by TLC. Then 18.1 gram of Ethoquad C/25 was added slowly and stirred at 80° C. for one hour. The reaction mixture was cooled to room temperature and 150 mL of chloroform was added. The chloroform layer was washed with water to remove salts. 27.5 gram of dark red viscous liquid with color value of 5.8 at the maximum absorption peak of 544 nm in methanol was obtained after removing chloroform.

### Example 4: Red Complex from Reactive Red 120, Jeffamine M-1000 and Benzyltriphenylphosphonium Chloride

7.35 gram of Reactive Red 120 (50% dye content), 5.0 gram of Jeffamine M-1000, 0.42 gram of sodium bicarbonate and 50 mL of water were charged into a reactor equipped with agitator, temperature control and condenser. The mixture was heated to 80° C. for several hours until the starting material Reactive Red 120 was gone as monitored by TLC. Then 5.85 gram of benzyltriphenylphosphonium chloride was added slowly and stirred at 80° C. for one hour. The reaction mixture was cooled to room temperature and 150 mL of chloroform was added. The chloroform layer was washed with water to remove salts. 15.4 gram of dark red paste with color value of 8.3 at the absorption maximum at 543 nm was obtained after removing chloroform.

### Example 5: Red Complex from Reactive Red 120, Diglycol Amine and Benzyltriphenylphosphonium Chloride

14.69 gram of Reactive Red 120 (50% dye content), 2.1 gram of diglycol amine, 1.05 gram of sodium bicarbonate and 50 mL of water were charged into a reactor equipped with agitator, temperature control and condenser. The mixture was heated to 80° C. for several hours until the starting material Reactive Red 120 was gone as monitored by TLC. Then 11.8 gram of benzyltriphenylphosphonium chloride was added slowly and stirred at 80° C. for one hour. The reaction mixture was cooled to room temperature and red solid was precipitated out of the liquid phase. The dark red solid was washed with copious amounts of water and dried. The obtained red powder had color value of 8.3 at the absorption maximum at 543 nm in methanol.

### Example 6: Yellow Complex from Reactive Yellow 81, Jeffamine M-1000 and Ethoquad C/25

8.2 gram of Reactive Yellow 81, 11 gram of Jeffamine M-1000, 0.84 gram of sodium bicarbonate, 26.9 gram of Ethoquad C/25 and 50 mL of water were charged into a reactor equipped with agitator, temperature control and condenser. The mixture was heated to 80° C. for several hours until the starting material Reactive Yellow 81 was gone as monitored by TLC. The reaction mixture was cooled to room temperature and 150 mL of chloroform was added. The chloroform layer was washed with water to remove salts. 43.9 gram of dark yellow viscous liquid with color value of 2.8 at the absorption peak of 366 nm was obtained after removing chloroform.

### Example 7: Violet Complex from Reactive Violet 5, Polyglycol Amine H-163 and Aliquat 336

7.36 gram of Reactive Violet 5, 4.89 gram of Polyglycol amine H-163, 0.84 gram of sodium bicarbonate, 8.09 gram of Aliquat® 336 and 50 mL of water were charged into a reactor equipped with agitator, temperature control and condenser. The mixture was heated to 80° C. for several hours until the starting material Reactive Violet 5 was completely reacted as monitored by TLC. The reaction mixture was cooled to room temperature and 150 mL of chloroform was added. The chloroform layer was washed with water to remove salts. 14.1 gram of dark violet paste with color value of 6.2 at the absorption peak of 565 nm was obtained after removing chloroform.

### Example 8: Black Complex from Reactive Black 5, Diglycol Amine, and Aliquat®336

36.08 gram of Reactive Black 5 (dye % is 55%), 6.3 gram of diglycol amine, 3.28 gram of sodium bicarbonate, and 50 mL of water were charged into a reactor equipped with agitator, temperature control and condenser. The mixture was heated to 60° C. for several hours until the starting material Reactive Black 5 was completely reacted as monitored by TLC. Then 16.2 gram of Aliquat®336 was slowly added to the reaction mixture at 60° C. and stirred for 1 hour. The reaction mixture was cooled to room temperature and dark blue-black solid was precipitated out. The solid was washed several times with copious amounts of water to remove inorganic salts. The obtained dark bluish black solid had an absorption peak at 587 nm in methanol.

### Example 9: Blue complex from Reactive Blue 4, diglycol amine, and Trihexyltetradecyl Phosphonium Chloride

9.1 gram of Reactive Blue 4 (dye % was 35%), 2.1 gram of diglycol amine, 1.0 gram of sodium bicarbonate, and 30 mL of water were charged into a reactor equipped with agitator, temperature control and condenser. The mixture was heated to 60° C. for several hours until the starting material Reactive Blue 4 was completely reacted as monitored by TLC. Then 5.19 gram of Trihexyltetradecylphosphonium chloride was slowly added to the reaction mixture at 60° C. and stirred for 1 hour. The reaction mixture was cooled to room temperature and dark blue solid was precipitated out. The solid was washed several times with copious amounts of water to remove inorganic salts. The obtained dark blue solid had an absorption peak at 628 nm in methanol.

### Example 10: Blue Complex from Reactive Blue 4, Diglycol Amine and BenzyltriphenylphosphoniumChloride

9.03 gram of Reactive Blue 4 (35% dye content), 2.21 gram of diglycol amine, 1.03 gram of sodium bicarbonate and 50 mL of water were charged into a reactor equipped with agitator, temperature control and condenser. The mixture was heated to 80° C. for several hours until the starting material Reactive Blue 4 was gone as monitored by TLC. Then 4.02 gram of benzyltriphenylphosphonium chloride was added slowly and stirred at 80° C. for one hour. The reaction mixture was cooled to room temperature and blue solid was precipitated out of the liquid phase. The dark blue solid was washed with copious amounts of water and dried. The obtained 8.63 gram blue powder had a color value of 6.05 at the absorption maximum at 591 nm in methanol.

### Applications of the Colorant Complexes

### Example A: Production of Colored Polyurethane Coating as Synthetic Leather

This example demonstrates the production of synthetic leather articles in accordance with the invention. 5 parts polymeric colorant complex red of EXAMPLE 1 was mixed well with 100 part of polyurethane resin SU-9704 from Stahl. This red polyurethane resin solution was directly applied onto a commercially available silicone-treated, mirror-surface release paper to form a film coating having a thickness of approximately 15 microns. A commercially available base substrate having a thickness of 1 mm (a non-woven fibrous sheet having a thickness of 80 microns and a polyurethane elastomer impregnated/coated and solidified on one side) was then pressed/bonded onto this film coating. Then, the assembly was heated to a temperature of approximately 120° C. in an oven and kept at that temperature for 3 minutes. The assembly was then removed from the oven and cooled down to room temperature, and the release paper was then peeled off of the assembly. A synthetic leather article having a red skin layer was thus obtained. Furthermore, no visible red color was detected on the release paper, which suggests that none of the red colorant had migrated onto the release paper. The synthetic leather article was tested for leather to leather migration. The synthetic leather article was pressed with clean white PVC or PU synthetic leather in 70° C. oven for 24 hours. Then the white PVC or PVC synthetic leather samples were measured for colors transferred from the inventive synthetic leather. No visible red color was detected on the PVC or PU synthetic test leather surface.

### Example B: Production of Colored Wax

The colorant complex of Example 1 was added to molten paraffin wax (melting point from 130-150° F.) in an amount of about 0.01% by weight and stirred until the molten wax became a homogeneous shade of light red. The colored molten wax was then poured into a mold (a nalgene beaker) and allowed to cool to form a uniform light red colored wax.

### Example C: Production of Colored Hydrocarbon Fuel and Fluid

The colorant complex of EXAMPLE 4 was added to kerosene in an amount of about 0.01% by weight and stirred until the composition became a homogeneous shade of light red.

### Example D: Production of Colored PVA Film

The colorant complex of EXAMPLE 3 was added to 30% wt PVA water solution (MW ˜108,000) in an amount of about 2% by weight and stirred until the composition became a homogeneous red solution. A uniform red freestanding film was obtained by drawdown on a glossy paper substrate and dried in 105° C. oven for 5 minutes.

### Example E: Production of Colored PU Foam

The colorant complex of Example 8 was added to a polyurethane foam formulation (4 part per hundred in polyol). Uniform black polyurethane foam was obtained.

### Example F: Production of Colored Liquid all-Purpose Cleaner

0.1 gram of Example 6 yellow complex was added into 100 gram of uncolored liquid all-purpose cleaner. Clear, uniform yellow all-purpose liquid cleaner was obtained.

### Example G: Production of Colored Liquid Detergent

0.1 gram of Example 3 red complex was added into 100 gram of uncolored AATCC standard liquid detergent. Clear, uniform red liquid detergent was obtained.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. An organic colorant complex with the following general structure (I):
ABₙ(DE)ₘTₓQ_{y} (I)
wherein
A is an organic chromophore selected from an azo, phthalocyanine or anthraquinone chromophore group;
B is an electrophilic reactive group selected from monochlorotriazine, monofluorotriazine, dichlorotriazine, sulfatoethyl sulfone, vinyl sulfone, 2,3-dichloroquinoxaline, and 2,4-difluor-5-chloropyrimidine groups and is covalently bonded to A directly or through a linking group;
D is a nucleophilic linking group covalently bonding B and E, selected from NR, O, S, and 4-oxyanilino (—HN-Ph-O—); wherein R is H, alkyl, aryl or E;
E is an organic moiety or an end group;
T is a cationic quaternary ammonium group covalently linked to A;
Q is a counterion, bonded to the organic chromophore through ionic interaction with T; and
n, m, x, and y each independently are integers of 1-10.

2. The use of the organic colorant complex of claim 1 for coloring media selected from polymers, aqueous solutions, thermoplastic composites, thermosets, waxes, ink formulations, plastics, detergents, soaps and crayons.
